(19) United States
(12) Patent Application Publication
(10) Pub. No.: US 2002/0065851 A1
(43) Pub. Date: May 30, 2002

(54) System and method for creating a website

(76) Inventors: Emerson C. Watson, Columbia, SC (US); Thomas Sliker, Wagener, SC (US); Scottie Claiborne, Irmo, SC (US); Marc Rosamond, Columbia, SC (US); Andrew Richbourg, Columbia, SC (US)

Correspondence Address: MICHAEL A. MANN, NEXSEN PRUET JACOBS & POLLARD LLC, PO DRWR 2426, COLUMBIA, SC, 29202-2426, US

(21) Appl. No.: 09/963,980

(22) Filed: Sep. 26, 2001

Related U.S. Application Data
(63) Continuation-in-part of application No. 09/669,832, filed on Sep. 26, 2000.
(60) Provisional application No. 60/209,159, filed on Jun. 2, 2000.

(51) Int. Cl. G06F 15/00

(52) U.S. Cl. 707/513

(57) ABSTRACT

A method for rapidly creating and altering a website comprises a plurality of activators, each of which is designed for a specific task, such as news listings, job listings, search interface, shopping cart or discussion board, and a database for storing content data and presentation logic. Each activator has a web server component and a business server component. The web server component can be called using server-side scripting and, when called, dynamically generates the HTML code needed for presenting the content data in accordance with the presentation logic stored in the database. The web server is capable of communicating with the business server component to forward requests for particular portions of a web page. The business server component in turn communicates with a database that houses both the content data and presentation logic. Activators interface with browser-based applications that are capable of enabling those specific activators desired for a particular web site and allows a user to add or modify the content data and the presentation logic in the database without first coding it in HTML.

### PRIORITY CLAIM

The applicants claim the benefit of the priority date of U.S. Provisional application Ser. No. 60/209159, filed Jun. 2, 2000, and U.S. non-Provisional application Ser. No. 09/669,832, filed Sep. 26, 2000.

### FIELD OF THE INVENTION

The present invention relates to a method and system for creating and using web sites. In particular, the present invention relates to a method and system that allows the rapid creation, deployment and alteration of web site content, layout and organization.

### BACKGROUND

A web site is a set of interconnected web pages that are generally prepared and presented as a collection of information. Generally, each web page is a text file containing code written typically in hypertext markup language (“HTML”). Each web page is assigned a uniform resource locator (“URL”), which is essentially an address path identifying the server that hosts the web page and the location of the web page on the server. The web pages can be viewed using a web browser, such as INTERNET EXPLORERTM and NETSCAPE NAVIGATORTM. Web browsers interpret the HTML coded file and display its content as the desired web page.

Originally, web sites were created by writing HTML text files line by line. Although HTML editors were eventually created to ease the difficulty of writing HTML files, the content was still typically coded into HTML. As a result, any changes to the content of a web page still required the skills of a web developer who understood the requirements and use of HTML. Hence, maintaining a web site that has constantly changing content became a difficult and expensive task.

More recently, with the advancement of web server applications, such as INTERNET INFORMATION SERVERTM (“IIS”), web developers have been able to take advantage of software applications that enable the dynamic generation of HTML for site content, such as ACTIVE SERVER PAGESTM (“ASP”), in combination with scripting applications. As a result, rather than laboriously coding content data within an HTML file in advance, the portions of the HTML file dealing with content can be automatically generated. A script, typically written in JAVASCRIPT™, VBSCRIPT™ or PERLSCRIPT™, within the ASP file queries a database in which the content is stored and automatically generates the appropriate HTML code “on the fly” based upon the results of the query so that the page is “assembled” from database content only when requested.

Unfortunately, although the textual content of a web page can be generated “on the fly,” the layout and presentation of the content are dependent upon the specific HTML code within an HTML or ASP file. As result, each web site that a web developer creates must be specifically coded to create a particular layout for a unique appearance, thereby substantially increasing the cost of developing a customized web site. Moreover, the HTML code that web developers laboriously create for presentation logic cannot generally be reused for other web sites unless each successive web site is formatted to look much like the first one—in short, a template approach—, which imposes significant restrictions in the allowed content and which inevitably falls short of the preferred “custom-designed” look. Consequently, the web developer must continually develop new code for presentation logic so that each web site has a different appearance. Accordingly, any changes to the layout and presentation of a web site is a time-intensive task that must be performed by a web developer knowledgeable in HTML.

Moreover, in the operation or development of a web site, the requirements of the owner may evolve rapidly. Sometimes the owner has a deadline for launching a new or renovated web site. Both of these factors can result, individually and in combination, in the expenditure of a large number of hours over very limited periods of time by web site developers to meet owners' requirements before the deadlines are reached. Inevitably, there are inefficiencies and errors that can result in these circumstances.

Therefore, there exists a need for a method and system for rapidly creating and altering web sites that do not limit the flexibility of the web site developer for creating custom-looking sites and enable the web site owner to easily change content.

### SUMMARY OF THE INVENTION

According to its major aspects and broadly stated, the present invention is a system and method for rapidly creating and easily maintaining a website. This system adds dynamic, database-driven functionality to what may otherwise be a static web site. The present invention comprises a system of software modules, or “activators” used with browser-based software applications for adding functionality and managing content, determining its presentation, and delivering it to those who have expressed an interest in receiving the information contained in the web site.

The activators are each designed for a specific task typical of web sites, such as a “news listing” activator, a “job listing” activator, a “search interface” activator, a “shopping cart” activator or a “discussion board” activator. One of the activators is a pro-active contact manager that helps the web site owner to group those who interact with the web site through a contact page by the nature of their interest and allows the owner to deliver relevant portions of website content with its fully navigable presentation to the intended recipient. Moreover, each activator can be added easily and quickly to a web site by someone having little or no skill in writing HTML.

Each activator has a web server component and a business server component. These components are “objects” in the sense of object-based computer programming. The web server component can be instantiated using server-side scripting. When called by the web server script, the web server component forwards to the business server component requests for particular portions of a web page. The business server component queries the database that houses both content data and presentation logic to obtain the values associated with the requested web page and passes them to the web server component, which dynamically generates HTML code needed for both content data and presentation logic. Thus, not only is the content of the web site generated dynamically, but the HTML code for presentation logic is generated dynamically as well.

Activators interface with three browser-based applications. The first is a “coding assistant” software application that is capable of enabling and disabling those specific activators that are to be part of a particular web site and of generating the presentation logic for the content data. The second is a browser-based, “administrator” software application that allows a user, with no understanding of HTML, to add or to modify content data. The third is a “manager” software application that allows a user, again with no knowledge of HTML, to manage the presentation data that relates directly to content, such as font. This is a “higher level of control over content than that provided by the administrator, hence, the “manager” designation.

The content data and the presentation logic for the various uses are both stored in a database where they are accessible by the activators' business components. The administrator/manager and coding assistant applications allow the user to then change the content data and the presentation logic, respectively, in the database without knowing HTML, and the activator will generate the HTML dynamically to accommodate the new content and the new presentation logic in the web site.

An important feature of the present invention is the dynamic generation of HTML for not only content data, but also presentation logic. Both content data and presentation logic are stored in a database from which they can be extracted and the corresponding HTML generated automatically by using a scripting software application to create the coding script when needed, rather than being coded in advance and entered directly into the web page, thereby reducing development time and cost, allowing the new content to be published quickly, and to enable organizations with little or no skill in HTML programming to modify both content and site appearance by simply populating the database using the browser-based administrator/manager and coding assistant applications.

A major advantage of the present invention is the ability to create web sites with substantially different appearance with just a few changes in software instructions. This advantage arises in part because the presentation data are not combined with content data or coded in HTML until a web page of the web site is requested. Because presentation data can then be stored separately, simple instructions can be given to select entirely different presentation data As a result, the time required for creation of different web sites is substantially reduced.

Another contributing factor to the simplicity of establishing or modifying a web site is the use of scripts to generate the presentation HTML dynamically, or “on the fly.” Furthermore, since the scripts that create the instances of the activators can be used repeatedly, they can be robust, thereby reducing errors that might otherwise occur when developing a customized website from the ground up.

The ability to change the appearance, organization and layout of the web site without the user understanding HTML is an important advantage of the present invention. This advantage arises from the combination of the browser-based administrator/manager and coding assistant. Since both content data and presentation logic are stored as entries within a database, rather than coded into each web page, a user need simply uses these applications to provide content and make selections as to presentation, without the need to understand the HTML that effects the user's choices.

The use of a data base to store presentation data is a very important feature of the present invention. This allows the presentation data to be combined with the content data when called and, correspondingly, to be separated from content prior to being called so that the content data does not need to be coded with presentation data by the person storing it in the database. It also allows the storage of a large number of presentation options from which one or more web site owners, all having access to the same database if desired, can select from.

Another feature of the present invention is the architecture of the database. As will be described below, the database has to be adapted to store different types of data in such a way that they can be combined. One database can be used for several websites, and, by so doing, maintaining and enhancing the capabilities of each can become easier.

Still another feature of the present invention is the ability to deliver a fully navigable website within the window of an email, rather than merely a link or by having another window pop up. This ability creates a new dimension for users of email to convey graphics as well as formatted text without customizing each email message, but merely by selecting the page to be delivered and the email addresses of the recipients. Other features and advantages of the present invention will be apparent to those skilled in the art from a careful reading of the Detailed Description of a Preferred Embodiment presented below and accompanied by the drawings.

### BRIEF DESCRIPTION OF THE DRAWINGS

In the drawings,

FIG. 1 is a schematic overview of the system architecture, according to a preferred embodiment of the present invention;

FIG. 2 is a schematic overview of an activator, according to a preferred embodiment of the present invention;

FIG. 3 is a schematic view of a news web server component for the system, according to a preferred embodiment of the present invention;

FIG. 4 is a schematic view of a news business server component for the system, according to a preferred embodiment of the present invention;

FIG. 5 is a timing chart illustrating the synchronous relationships between components of the system configured for an activator, here, namely, a news list, according to a preferred embodiment of the present invention;

FIGS. 6A and 6B illustrate the use of the browser-based coding assistant for entering news presentation data into the database;

FIGS. 7A and 7B illustrate the use of the browser-based content administrator for entering news content into the database;

FIG. 8 illustrates a screen shot of a global styles selection page of the content manager application, according to a preferred embodiment of the present invention;

FIGS. 9A and 9B illustrate the use of the contact manager activator in sending content to a third party;

FIG. 10 illustrates schematically a flow chart of the method for delivering a page from a website via email.

### DETAILED DESCRIPTION OF A PREFERRED EMBODIMENT

Referring now to the figures, the present invention is a system and method for rapidly establishing and altering a website. Web sites established by the present system and method need not reside on the Internet, but could also reside on an intranet, extranet or other computer network; likewise, any communication system capable of accessing a web site, such as a modem, a network interface card, or a wireless communications system could be used to access a web site created by the present system and method.

Each web page within a web site has content data and presentation logic or “meta data”. Content data is the information displayed on the web page, whether in text, graphics, audio, video or the like. Presentation logic is generally not seen by the user, but specifies the organization, layout and format in which the content data will be presented to the user, such as colors of the background and text, font type, font size, table format, linking relationships and placement of text and images. Presentation logic encompasses any tag available in HTML that controls web page format. For other examples of presentation logic, see http://www.w3.org/MarkUp/, which is hereby incorporated by reference.

Although content data and presentation logic are typically specifically encoded into web pages, the present system separately stores both content data and presentation logic in a database. Moreover, both content data and presentation logic are made easily modifiable by a user of the present system who need not be knowledgeable in HTML. This in an important point. The user does not need to understand HTML and the user, regardless of familiarity or expertise with HTML, does not need to code the content data and presentation logic. Accordingly, each web page has a script that simply causes the content data and presentation logic to be obtained from the database and to generate HTML code corresponding to the content data and presentation logic dynamically.

Current web site designs range in complexity from simple static pages to dynamic, highly functional web sites. Although the range in capabilities is large, there are certain functional features that are common to a large number of web sites and are desirable to a large number of businesses and other entities.

For example, many businesses prefer to have a page devoted to news about the company or its products and services. Many businesses want to use their web sites as a route for potential employees to find jobs with the business or for potential customers to obtain more information about the products and services of the business. Online retailers frequently want a “shopping cart” capability and a capability to process credit cards.

Some of these functions are nearly standard features of large classes of web sites. Some require frequent changes in content. Both types are ideal candidates for the present invention because activators can be generated that permit those with little or no training in HTML to install them into the web site and update the content.

Within each one of these functions (news listings, job postings, contact forms, shopping carts, etc.), there are always several ways to present the information. News for example, may be displayed as a series of horizontal paragraphs. A contact sheet may be a series of dialog boxes, but some contact sheets require different categories of information. These different presentation schemes can be stored in a database and then selected for use in a web site using the activator with the appropriate function.

The present system comprises a manager application, an administrator application and a coding assistant application and at least one activator that allows rapid development of web sites having the functionality of that activator. Activators can be developed for common features of many websites including, but not limited to, news lists, events lists, jobs lists, contact forms, products lists, references, search capabilities, resources, catalogs, security, newsletters, inventory, reference libraries, people finders, location finders, “shopping carts”, discussion boards, document sharing extranets, configurators, customer profiling, behavior tracking and industry-specific applications. Activators interface with the browser-based coding assistant application that is capable of enabling and disabling the specific activators available for use in connection with a particular web site. They also interface with the browser-based administrator and manager applications that allow a user to add or modify content data or content-related presentation logic that corresponds to the enabled activators without knowing HTML.

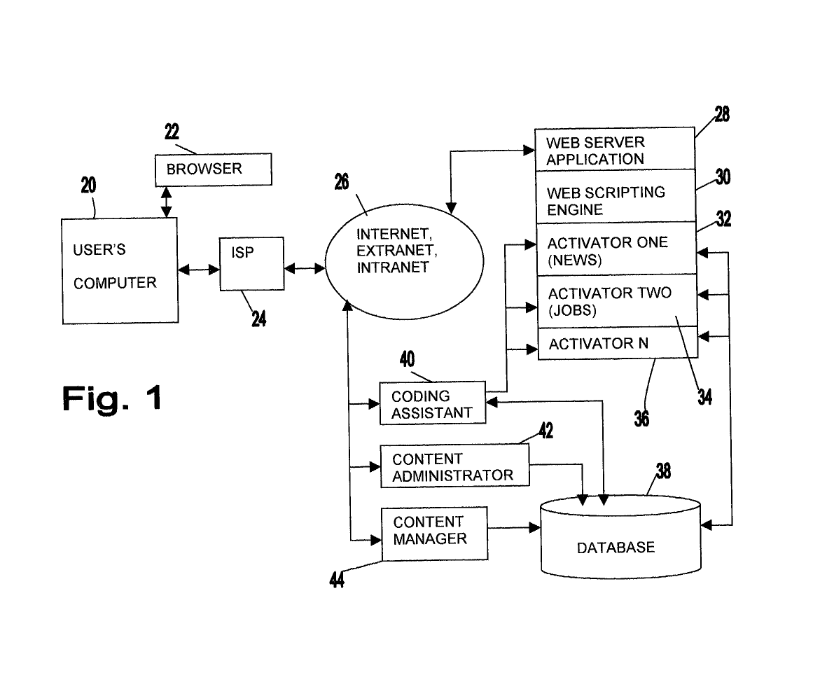

FIG. 1 illustrates schematically an overview of the present invention. A user accesses the system through a computer 20 with a browser 22 and internet access provided by an internet service provider (ISP) 24. The internet service provider provides access to the internet 26 or, alternatively, an extranet or intranet.

The user's browser 22 accesses a web server 28 hosting the web site where a web scripting engine 30 generates scripts that call the desired activator. Activator one 32 is a news activator; activator two 34 is a jobs activator; activator three 36 is a contact activator, and so forth. These activators access a database 38 for the content data and presentation data stored therein and return them to the web scripting engine that generates HTML based on the instructions from activators 32, 34, 36 or other activator. The thus-generated source code is delivered to user's computer 20 where browser 22 causes the source code to be displayed as a web page.

If the user is authorized to change the content or presentation data, it can also access a coding assistant 40 that activates or deactivates the activators 32, 34, 36, etc., individually, and helps the user to select the presentation data desired. The user can also load content and content-related presentation data into database 38 using a content administrator 42 and a content manager 44.

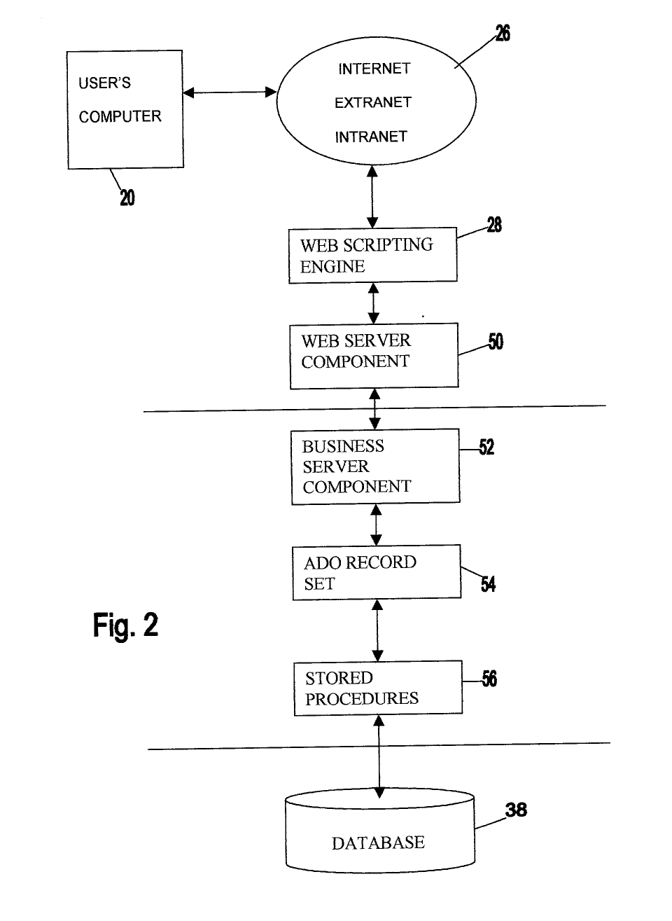

Referring to FIG. 2, each activator comprises two components that are configured in a layered architecture. Each component is designed for a specific purpose and cooperates with the other component to serve the overall purpose of the activator. The component in the first layer of architecture, which is called the web server component 50, encapsulates presentation logic and generates the appropriate HTML. The component in the second layer, called the business server component 52, encapsulates the logic for the specific task that a particular activator is intended to perform. Used herein, “logic” includes software instructions and data structures, such as arrays and the like.

The web server component uses server-side scripting to load content data and presentation logic from database 38. Server-side scripting enables the dynamic generation of HTML that is then communicated to the user's browser 22.

In simple prior art web pages, the user requests a web page from a server and the server simply sends the pre-HTML-coded file to the user, which is parsed and displayed by the user's browser. Server-side scripting, however, is used by a server to alter the file or access other applications before the file is sent to the user.

Here, in the present invention, that capability of server-side scripting is used to advantage, using the script to code the file. Accordingly, the HTML for web pages using server-side scripting can be generated dynamically by the script using web server component 50. This is an important feature of the present invention.

Depending upon the desired platform, web server component 50 could use any one of a variety of different server-side scripting engines 28. Preferably, web server component 50 uses ACTIVE SERVER PAGES (“ASP”) scripting by MICROSOFT. Although ASP is generally limited to the WINDOWS NT™ platform, an ASP equivalent system that runs on other platforms, such as CHILI!SOFT ASP™ by Chili!Soft or INSTANT ASP™ by Halycon could be easily substituted. Likewise, other server-side scripting architectures, such as Common Gateway Interface (“CGI”) or JAVA SERVER PAGES™ by Sun Microsystems could be used.

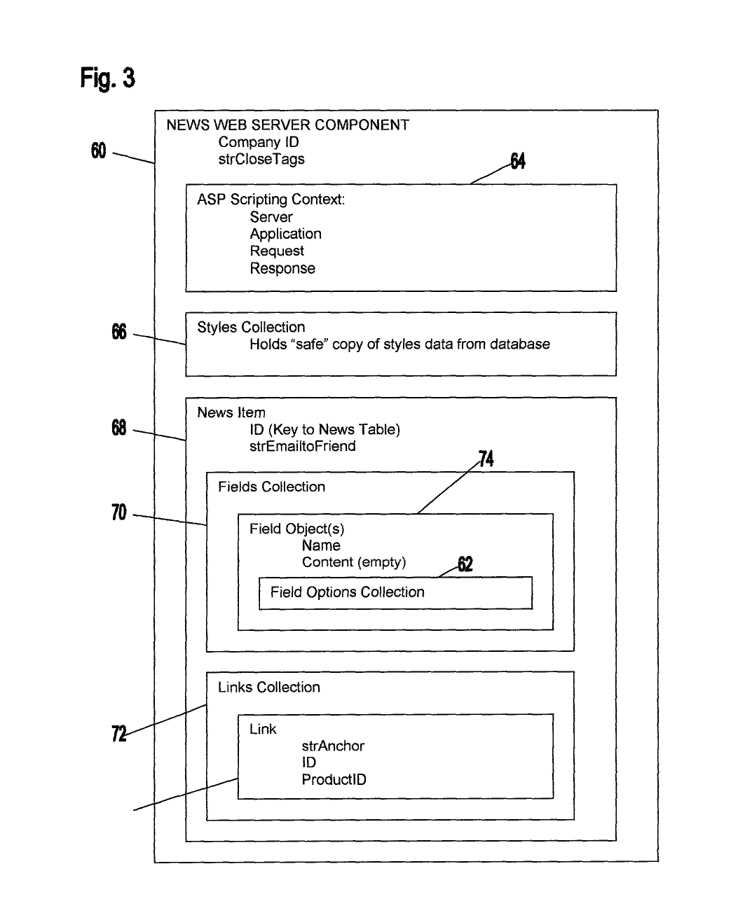

Referring to FIG. 3, there is shown a schematic view of a web server component of a particular activator 60, namely a “news” list. The web server component is an “encapsulated object” that may be instantiated by server side scripting within a web page. Web server component 60 is a software “object” having “private” or internal properties and methods and “public” or external properties and methods. The private properties of web server component 60 are “hidden” or encapsulated. By encapsulating the private properties and methods and processing them within web server component 60, they can be modified without affecting the public properties and methods. Since the private properties and methods are encapsulated, web server component 60 will interact strictly through the script messages passed from web server component 60 to the server or to the business server component (or another one of its “clients”) by calling the public methods of other objects. Once web server component 60 is instantiated, any public method of web server component 60 may be called or any public property retrieved. The private members and private members of web server component 60 can not be accessed directly by a business server component or web server (or other client of the web server component). Instead, web server component 60 can only be called via public methods.

FIG. 3 illustrates the private properties of web server component 60. Although web server component 60 is described in conjunction with its use as a news list for purposes of this illustration, it will be clear to one of ordinary skill in the art that web server component 60 could be easily adapted for use with any other web site related object, such as a jobs list, search interface, shopping cart or discussion board or other object. Each web server component that is instantiated has an identification, referred to, for example, as CompanyID. This identification contains the ID of the user accessing the web server script that instantiated web server component 60. Alternatively, the identification may be contained in a software “cookie” stored on the user's computer or coded into the web page if the web site is dedicated to a single customer.

Another private property of web server component 60 is “strCloseTags”. strCloseTags is a string variable that stores HTML tag data received from a business server component. When a business server component returns data written in HTML as a field option, the HTML data will have an opening and closing tag. (A “tag” is a code used in HTML to define a format change or hypertext link. HTML tags are surrounded by the angle brackets “<” and “>.”) Upon receiving the HTML data, web server component 60 will parse the opening HTML tag and place it in a fields collection 70—a data structure—and concatenates the closing HTML tag into strCloseTags with the other closing string tags.

Other private properties of the web server component include the intrinsic variables in a web server scripting engine context 64. In the case of ASP, these include objServer, objApplication, objRequest and objResponse. These variables are standard variables used in ASP and can be used as described by the assorted documentation to ASP. See, for example, Shelley Powers, Developing Web Components (1999), which is hereby incorporated by reference.

colStyles is a private property of web server component 60 that holds the styles collection 66 of the items on the news list and the news list itself. colStyles is a collection of objects containing style option data received from the business server component. Any data stored in colStyles may be overwritten by the business server component.

Web server component 60 also has a news item object 68 with fields collection 70 and a links collection 72 as private properties. Fields collection will receive field objects 74 and field option collection 62 from business server component 52.

News item object 68 describes one news item on a web page. Each instantiated news item object 68 has an ID that corresponds to the key to the database for that news item. Optionally, the news item object may contain a string, strEmailtoFriend, for storing an e-mail address to send the news item. News item object 68 has fields collection 70 containing the content for the news item. Additionally, links collection 72 stores hypertext anchors so that the news item can be linked to other portions of the web site.

Preferably, web server component 60 contains the following public methods displayed in Table A for a news list. Each of these public methods may be accessed from an ASP page.

TABLE A

| PUBLIC METHOD NAME | DESCRIPTION |
|---|---|
| OnStartPage() | gets references to the intrinsic ASP |
| | objects from the scripting context; gets |
| | the ID of the entity accessing the ASP |
| | page; instantiates the business server |
| | component; loads styles data from the |
| | business server component; |
| | instantiates a log client component; |
| | instantiates a data mine component |
| NewsPageList() | retrieves fields, field options and |
| | relevant product options from business |
| | server component; receives all fields |
| | provided from a single news item; |
| | writes item to ASP response object in |
| | appropriately formatted HTML; loops |
| | retrieving and presenting items until |
| | out of items or maximum number of |
| | items per page is reached |
| FrontPageList() | retrieves fields, field options and |
| | relevant product options from business |
| | server component; receives all fields |
| | provided from a single news item; |
| | writes item to ASP response object in |
| | appropriately formatted HTML; loops |
| | retrieving and presenting items until |
| | out of items or maximum number of |
| | items per page is reached |
| ViewItem() | gets fields, field options, and relevant |
| | product options from business server |
| | component; presents data in ASP |
| | response object |
| EditItem() | gets fields, field options, and relevant |
| | product options from business server |
| | component; present data in ASP |
| | response object |
| CreateNewItem(IN varItem) | passes field content to business server |
| | component for insertion into database |
| UpdateItem(IN varItem) | passes field content to business server |
| | component for insertion into database |
| SetFieldOption(IN FieldName, | overrides the database determined |
| IN OptionName, IN | value for a specific option |
| OptionValue) | |
| SetStyleOption(IN StyleName, | overrides the database determined |
| IN Value) | value for a specific option |

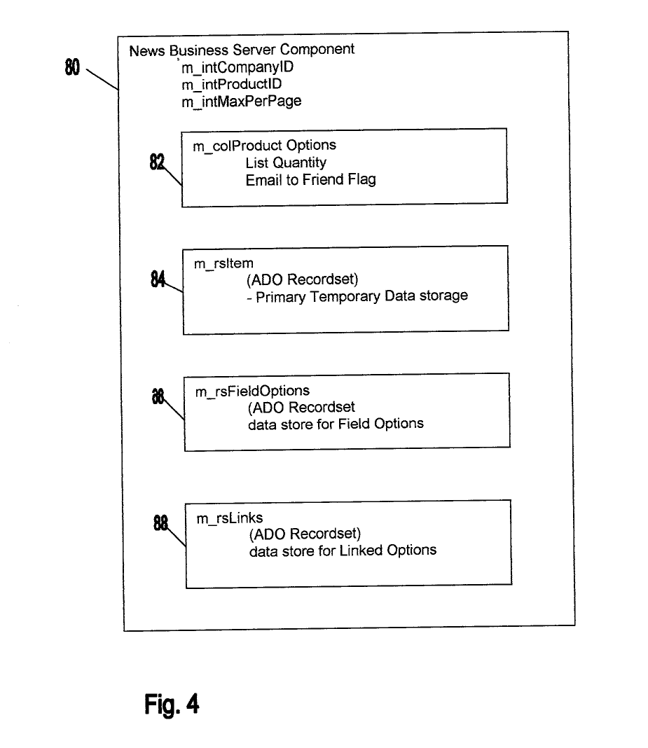

The present system has a news business server component 80 in the second layer of its architecture, as shown in FIG. 4. Business server component 80 communicates with both web server component 60and database 38 and manages the request for data from web server component 60 in finding that data in database 38 and retrieving it. Like web server component 60, business server component 80 is an encapsulated object. Accordingly, the private properties and methods of the business server component are hidden, thereby preventing direct access. Instead, business server component 80 is designed to operate with web server component 60 strictly through the messages passed by accessing any public methods or public properties. Once business server component 80 is instantiated, any public method of business server component 80 may be called or any public property retrieved. Thus, business server component 80 acts as an encapsulated interface to database 38.

FIG. 4 illustrates the private properties of a news business server component 80. Although new business server component 80 is described in conjunction with its use as a news list for purposes of illustration, it will be clear to one of ordinary skill in the art that news business server component 80 could be easily adapted for use with any other web site related object, such as a jobs list, search interface, shopping cart or discussion board or other object. Each news business server component 80 that is instantiated has an identification, m_intCompanyID. This identification is passed to news business server component 80 when it is instantiated by an external client, such as web server component 60, by using the “Initialize” method described in Table B. In addition, business server component 80 has a private variable for the identification of the item described in the list, m_intProductID, and a private variable for the maximum number of items to be displayed on the list for the current page, m_intMaxPerPage. These variables may be populated by querying the database.

The business web server also has other private properties for storing information regarding content and presentation logic information that are retrieved from the database. m_colProductOptions 82 is a collection of list objects that describe various options for the presentation of the list objects, each option being referred to as a product. Also, three record sets, 84, 86, and 88, each of a type such as Microsoft's ActiveX Database Object™, (“ADODB”) contain information related to presentation options for the items in the list and links to other portions of the website. These record sets include an item recordset, m_rsltem recordset 84; a fields options record set, m_rsFieldOptions 86; and a links record set, m_rsLinks 88. All three record sets are received via stored procedures 56 and ADO Record sets 54 from database 38 (FIG. 2).

News business server component 80 has two types of public methods: business use-case methods and data exchange methods. A business use can be any one of the purposes for which an activator can be designed, such as a “news” activator in the present example. For a listing of the preferred public methods for this particular use, see Table B. When a business use-case method is called, all operations involved in the execution of that business use scenario are handled by new business server component 80, including storage/retrieval of data from database 38, storage of data mine information, sending of appropriate e-mail notifications, etc. If the business process results in the retrieval of data from database 38, news business server component 80 will preferably retrieve the data by calling a stored procedure in database 38 and placing the results in an appropriate record set, preferably a record set. With respect to the data exchange methods, news business server component 38 has public methods for exchanging data with external clients so that data can be passed across multiple hardware components and their corresponding software (i.e., “platforms”).

Preferably, news business server component 80 contains the public methods displayed in Table B, following, to implement a news list. Each of these public methods may be accessed via an external client, such as the web server component.

TABLE B

| PUBLIC METHOD NAME | DESCRIPTION |
|---|---|
| ClassInitialize() | sets the value of intProductID, |
| | retrieves database connection |
| | information from registry, creates |
| | global database objects. If registry |
| | keys are missing, writes the default |
| | keys and values to the registry |
| Initialize(IntCustID) | gets the identification of the entity that |
| | instantiated the business server |
| | component |
| LoadNewsPageList() | calls a stored procedure that retrieves |
| | all relevant news articles from the |
| | database based upon product options, |
| | product-list-options, and product list- |
| | fields. Also, calls another stored |
| | procedure that loads appropriate field. |
| LoadFrontPageList() | calls a stored procedure that retrieves |
| | all relevant news articles from the |
| | database based upon product options, |
| | product-list-options, and product list- |
| | fields. Also, calls another stored |
| | procedure that loads appropriate field. |
| GetItem(varPresentable) | returns the contents of the current |
| | record in the items recordset along |
| | with all applicable field options for |
| | each field. Makes next record the |
| | current record when finished |
| GetStyles (varStyles) | calls stored procedure that returns all |
| | relevant styles data, package the data |
| | in a variant and return to caller |
| GetNumItemsPerPage() | returns contents of m_intMaxPerPage |
| GetViewItem(intID, varPresentable) | accepts the base table ID key and |
| | returns the appropriate fields and field |
| | options of the requested record |
| GetEditItem(intID, varPresentable) | accepts the base table ID key and |
| | returns the appropriate fields and field |
| | options of the requested record |
| UpdateItem(varContent) | accepts a variant containing fields to |
| | be used in updating an existing record |
| | in the database |
| CreateNewItem(varContent) | accepts a variant containing fields to |
| | be used in inserting a new record in the |
| | database |
| GetProductOption(intOptionNum, | retrieves the value of the product |
| varValue) | option corresponding to intOptionNum |

News business server component 80 communicates with database 38 that houses content data and presentation logic. Although news business server component 80 could contain specific queries based upon the task to be performed, preferably, database 38 has ADO record sets 54 and stored procedures 56 (FIG. 2) that can be called by business server component 80. A list and description of preferred stored procedures for the new list example are displayed in Table C.

TABLE C

| STORED PROCEDURE | DESCRIPTION |
|---|---|
| sp_GetNewsPageList(CompanyID int, | wrapper procedure that calls |
| num_months int) | sp_GetNewsList with the appropriate |
| | parameters to retrieve records for the |
| | news page list |
| sp_GetFrontPageNewsList | wrapper procedure that calls |
| (CompanyID int, num_months int) | sp_GetNewsList with the appropriate |
| | parameters to retrieve records for the |
| | front page news list |
| sp_GetNewsList (CompanyId int, | base procedure that is shared by the |
| num_months int, ListID int) | other list-retrieving stored procedures |
| | and contains logic to assemble the |
| | appropriate dynamic query string to |
| | retrieve any list of news items |
| | according to the rules stored in the |
| | database |
| sp_GetFieldOptions (listID int) | retrieves all field option records |
| | relevant to a particular list for a |
| | particular company |
| sp_ViewNewsItem (ID int) | retrieves a single record from the base |
| | news table for viewing purposes |
| sp_EditNewsItem(ID int) | retrieves a single record from the base |
| | news table for editing purposes |
| sp_GetProductOptions (CompanyID | retrieves all news product options for |
| int) | the specified company |
| sp_GetProductStyles (CompanyID int) | retrieves all styles data for the |
| | specified company |
| sp_GetLinks (CompanyID int) | retrieves all links data for the specified |
| | company |

The present system makes use of database 38 for storing information in four categories: user profiles, user content, and services. It will to clear one of ordinary skill in the art that the structure of database 38 could be implemented numerous ways to store the relevant data for retrieval. In the first category of data, user profiles, the data includes the user's name, web site locations, graphics locations, and the identity of the activators the client will use and the corresponding, exercised options. For example, if the user has selected the “jobs” activator, the user may also have elected the option to respond to an inquiry about a job. The email address of the prospective applicant and the message text are needed to compose and send the response automatically.

The user content data in the database includes any information the user wishes to display in the web site. In the event the user has selected the “jobs” activator, for example, this data would include information such as job description, title and location.

The user data mine includes any information added to database 38 as a result of the web site visitor's interaction with the site. For example, this data could include logging visits by the visitor, behavior tracking, the content input by the visitor to web site forms and visitors' purchase requests.

Services data includes information about the activators, their corresponding options selected and the default values for the options. If the “jobs” activator is selected, for example, then these data include the fields used to describe a job, whether or not the job title is free form or comes from a “drop down” list, and the contact name if any for a particular job.

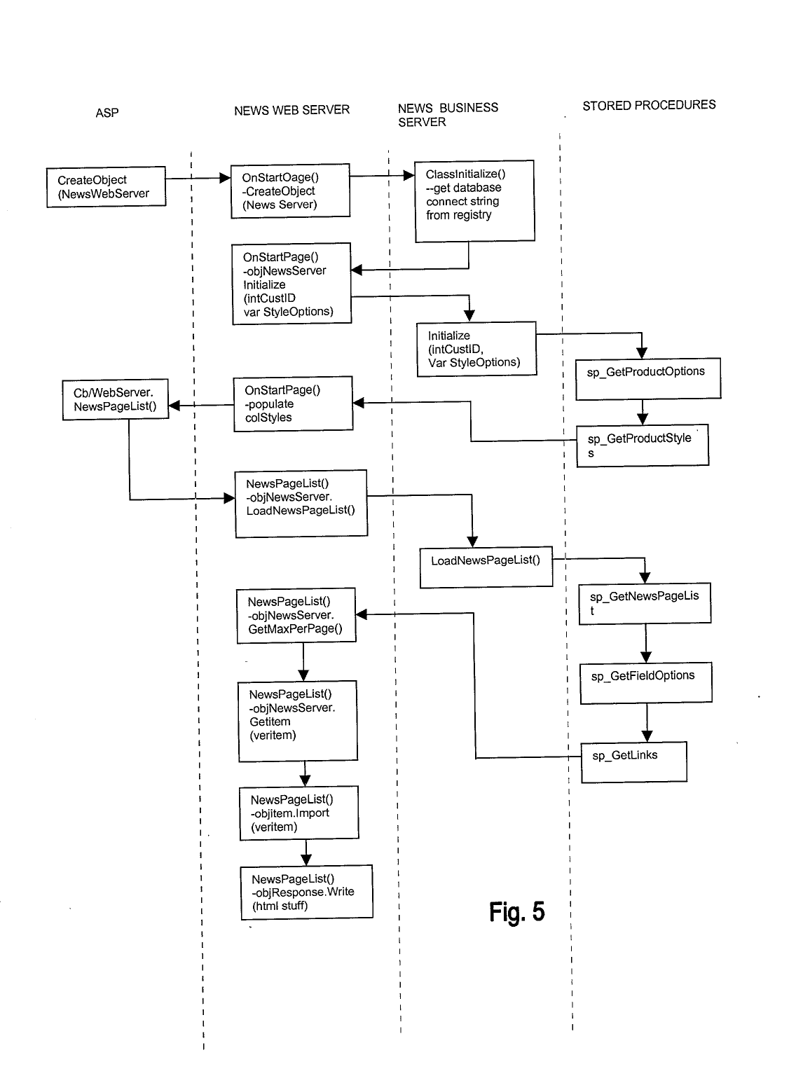

Referring to FIG. 5, there is illustrated a flow chart showing the timing of interactions between the components of an activator. Although the flow chart shows the process for a news list, it is clear that the flow chart will vary depending upon the task that the activator is intended to accomplish.

Note in FIG. 5 that the sequence illustrated is for a news activator retrieving and displaying the content of a news list. The sequence begins when the scripting engine instantiates the news web server object, which in turn instantiates the news business server. The process proceeds with signals moving among the scripting engine, web server component, business server component and stored procedures that are obtained from the database. The particular steps are best understood in the context of the description of each variable in Tables A, B and C.

In addition to the activators, there are three software programs that establish user interfaces needed by a user. One of them is for enabling the specific activators and general presentation logic and the other two are for controlling the content-specific presentation logic and content data of the web site.

The first application, coding assistant 40, allows the user to place the source code including scripting for the website into database 38; the second, content administrator 42, allows the user to place the content into database 38. The third, content manager 44, allows content-specific, or “look and feel” presentation logic to be entered into database 38. When called, the presentation logic and content data are brought together so that the source code generates the balance of the HTML for the content “on the fly.” Coding assistant 40, a browser-based application, enables or disables specific activators for a particular web site. For example, if a web site is capable of having a news listings activator, job listings activator, a search interface activator, shopping cart activator and a discussion board activator, coding assistant 40 allows each one of these activators to either be enabled or disabled, at the user's direction. The structure of the web site will depend upon which activators have been enabled by coding assistant 40.

Content administrator 42, a browser-based application, allows a user to add or modify content data and some presentation logic to the database. For example, if a word in a text was to be highlighted, content administrator 42 would enable the user to add the highlight logic to the text. Content administrator 42 will provide an interface to database 38, so that entries can be added, modified or deleted without knowledge of HTML.

Content manager 44, also browser-based, allows the user to establish the look and feel of the content. For example, fonts are selected using content manager 44. The location of new items on a web page and whether they are listed from oldest to newest, on the other hand, as well as whether there is a news items list, is determined by coding assistant 40.

Web server component 60 generates the HTML for the content data and presentation logic when these are called.

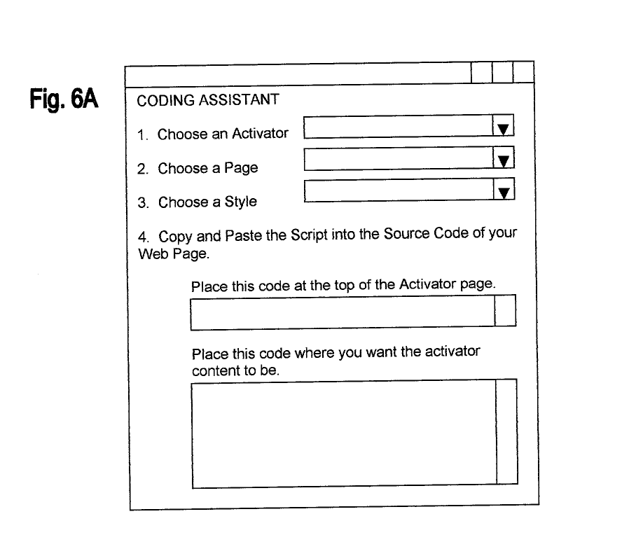

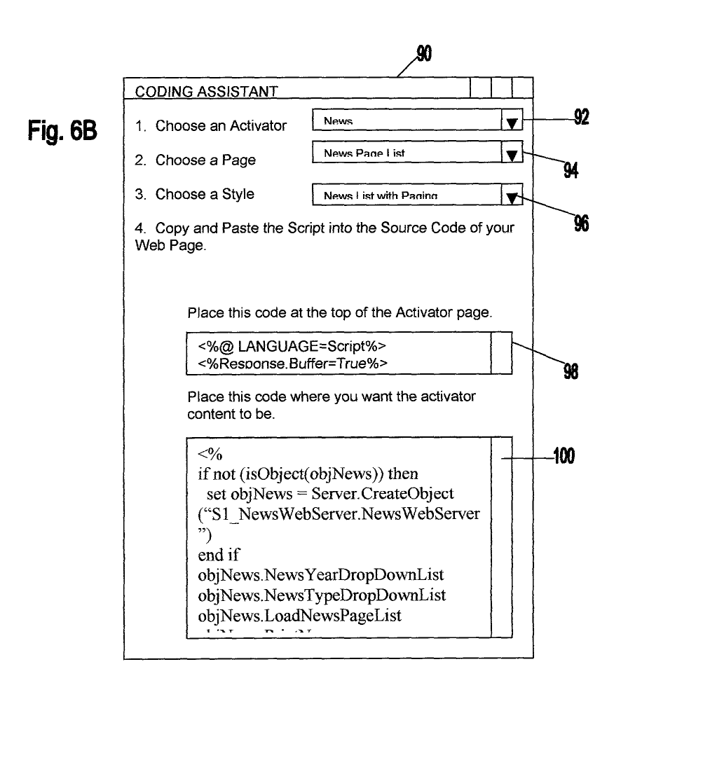

FIGS. 6A and 6B illustrate the operation of coding assistant by a screen shot of the user interface 90. The assistant (FIG. 6A) requires the user to make three selections. The first is selection is the type of activator that the user wants the material used with. For example, if the new content is a news release, the news activator (FIG. 6B) is the one with which the user will want the news release associated. If the new content is a job posting, the user will select the “Jobs” levitator. A drop down menu 92 showing choices of activators installed is preferred for simplifying the selection of activator.

The second selection the user must make is the page selection area (FIG. 6B). As with the selection of activator, a drop down menu 94 of choices of page is provided. Once the activator is chosen the choices of pages available will be presented and the user must make a selection as to which page the material will be added. These selections will be seen to represent a decision tree. Once the activator is chosen, the choices of page can be defined. Similarly, once the choice of page is made, the choice of style is defined. For the “news” activator, the user may select, for example, the “news page list” as illustrated

The third and final selection for the user is the style selection (FIG. 6B). For the news activator and news page list, the selections from a third drop down menu 96 will facilitate choices include a news list with paging style, a columnar style and a linear style for the content. The choice shown in FIG. 6B is the news list with paging.

The assistant then proceeds to generate a header code and a body code for the content, as shown in FIG. 6B, in a header dialog box 98 and a body dialog box 100. A comparison of FIGS. 6A and 6B will show boxes 98 and 100 in FIG. 6B contain scripting codes that tell the web server to expect scripting on the page (such as, for example, VBScript), and the code necessary to present the “Response” object, which is necessary for the proper response of the activator. The user is then inserts these two portions of codes in the appropriate place in the source code of the page where the content is to be displayed. Insertion is done by copying and pasting the code that appears in a dialog box. The header code is inserted just before any HTML code on the page that he wishes to use to display the content. The body code is inserted at the appropriate place in the source code so that it will appear on the page at the desired place.

The body code contains the code needed to set a server object and the subsequent methods (function calls) of that object so that the body code can call and print the content on the loaded page.

Coding assistant 40 (FIG. 1) can be launched by accessing a network or by logging on to a web site using a customized universal resource locator (URL) and passing through security that requires the usual “userid” and “password” or by clicking on a hyperlink included with his or her favorite URLs to create the shortcut to the website housing the assistant.

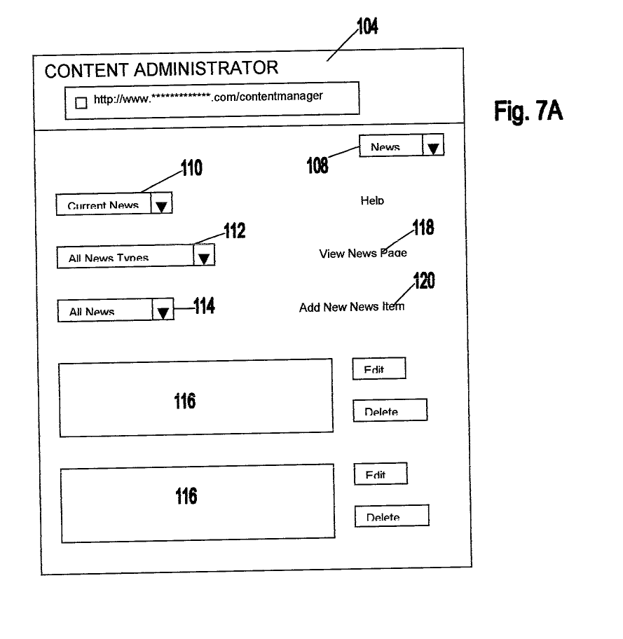

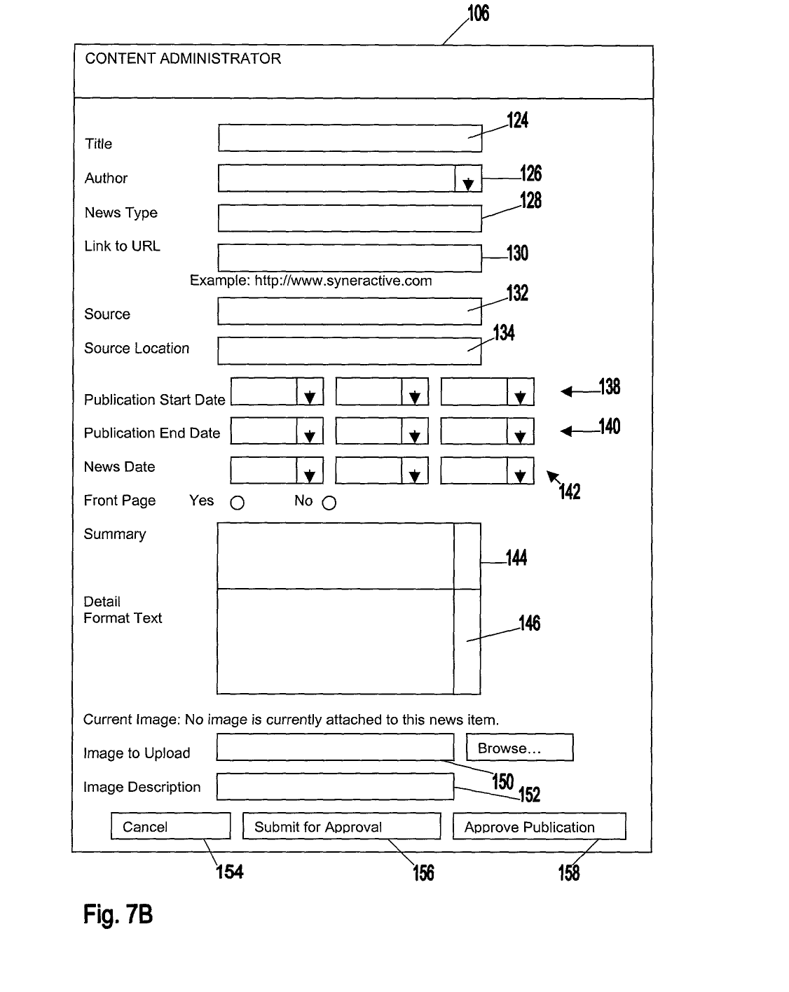

FIGS. 7A and 7B illustrate screen shots 104 and 106 of the browser-based administrator application which allows a user who may be unfamiliar with HTML to select content material for use in a web site and deliver it to a table cell in the database supporting the web site. After first making a selection as to which activator the user is supplying material using drop down menu box 108, and in the case shown in FIG. 7A, the selection is again the “news” activator, the user has several other choices to make to focus on the particular selection and presentation of new. The individual items of “current news”, of “all news types” showing “all items” may be selected from drop down menus of options 110, 112, and 114. These particular selections produce a list of news items 116. Each item 116 in the list will includes the title, the publication date and a brief summary.

The user may also choose to view the news page or add a new news item by clicking on the appropriate links 118, 120. A series of dialog boxes appear (FIG. 7B) when “Add New News Item” is selected. The information required includes the title in box 124, the author's name in box 126, the news type in box 128, any links to universal resource locators (URLs) in box 130. If the news comes from a different source, this source can be identified in box 132 along with the source location in box 134. Publishing start date, publishing end date, and the date of the news item itself can be specified in boxes 138, 140 and 142.

The user enters the summary in box 144 and the full text in box 146. The full text can be entered electronically if the news article is contained in a storage medium anywhere on the network the user has access to.

If any formatting is required, such as italicizing a word or underlining a word or using a word as a hyperlink, the user first highlights the word or phrase, then clicks on the “format text” link 148 which causes a pop up box with formatting options to appear. The selection of the preferred choice causes the highlighted word or phrase to be coded in HTML so that it will have the appropriate formatting automatically when displayed on the web site.

Content administrator has several tools for formatting that simplify the process of establishing content-specific presentation logic. It includes, for example, a “link tag builder” for those unfamiliar with HTML the process of creating links. By highlighting the word, phrase, or other object that is to be a link and then clicking on “link tag builder” tool, typing in the name of the page the user wishes the link to refer to, the link is created automatically from the word, etc., to the desired page. Another tool, a “font tag builder” allows the user to specify a font, font size, font color, alignment requirements, and whether the text is to be bold or italicized for specifically highlighted text.

If there are images that are to accompany the text, the location of the image is entered in box 150. A title or short description of the image can be entered in box 152.

If the user does not have the authority to publish the material, content administrator 42 (FIG. 1) will send an email to the individual who does for final clearance.

To use content administrator 42, the user logs onto a network or the internet, accessing the Administrator via a URL customized to the user's web site. Security may be provided in the form of a userid and a password, and may have two levels. For example, a particular user may be a “contributor” or a “publisher.” The contributor can input and update content but cannot publish it. Rather, the contributor can only submit the content for approval. Only when the content is approved by a publisher does it go to the web site. Screen shot 106 (FIG. 7B) allows the user to cancel the entered item, submit it for approval to someone with publishing authority, or approve for publication if the recipient has publishing authority, using boxes 154, 156 and 158, respectively

Either a contributor or a publisher can input content, can maintain or delete existing content, can view specific types of content (such as unapproved items, different categories of content or content sort by age, view the profiles of site visitors who complete the contact forms to determine what groups they might fall into, group the site visitors, send email or site content to groups of visitors in any of several formats, set up an information form to be displayed on the web site for gathering additional information, and view feedback results in content such as the number of times an item has been viewed and the number of applications and registrations received as a result of it.

Content manager 44 allows a user to establish content-specific presentation logic for the web site. For example, the choice of font should be uniform throughout each news list page (indeed, throughout the web site). If each news article is to have an underlined title, perhaps displayed in a color, these types of “look and feel” aspects of the content are prescribed using content manager 44.

Content manager 44 allows the user to set the broad presentation guidelines for content. For example, it allows colors of text to be selected for fonts, toolbars, backgrounds and banners. Preferably a large assortment of colors are made available, most preferably 216 colors. Content manager displays choices of colors from a palette or provides sliding scales of three colors (red, green, blue) to allow the user to mix them to obtain the desired final color choice. A user-friendly graphical user interface using standard tools such as dialog boxes, windows, virtual buttons, virtual sliding buttons, and point-and-click choice indication software allows the user to effect a color choice. Virtual buttons such as submit, cancel, reset can be used to confirm, reject or change the choices made.

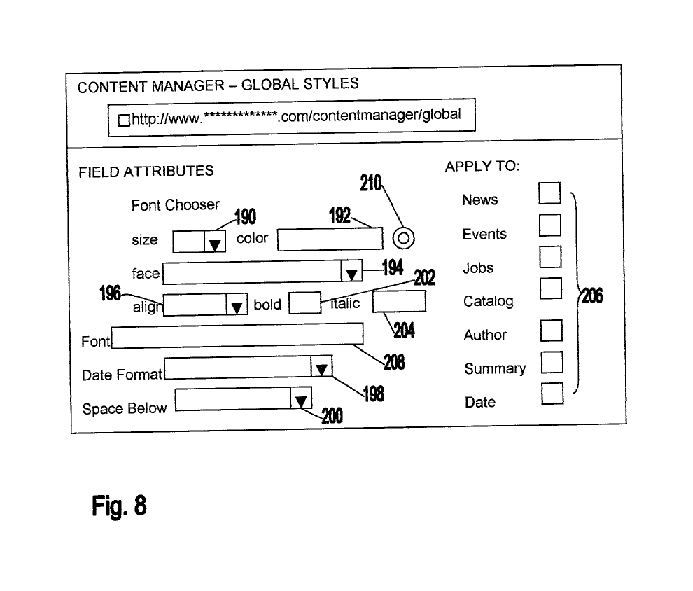

FIG. 8 illustrates the global styles selector screen shot for selecting styles of font, font size, font color, font bolding or italicizing, date format, text alignment, and spaces below an item for each page, and, indeed, for multiple activators. The choices provided are listed in pull down menus at font size box 190, font color box 192, font face box 194, text alignment box 196, date format box 198, space below box 200. If the font is to be bolded, box 202 can be “clicked on”; if the font is to be italicized, box 204 can be “clicked on.” These choices can be made to apply to some or all of the activators that are being used by “clicking on” the boxes 206 adjacent to the name of the activator. The font selection is displayed in box 208. Help in selecting color is obtained by clicking on button 210 which causes a color selection palette to appear.

The user can also use content manager 44 to specify the fields displayed from the available fields. For example, if the news activator is active, the available fields may include author, summary, news date, and title. The user may wish to specify the use of only author, summary, and title but not the news date. Content manager 44 can also be used to specify font, space between items in a news list, and the use of titles of news or article summaries as links to the full news content or article.

Content manager 44 allows the user to specify titles, such as, for example, “press releases” or “company news” or “what's news” for a news activator.

The content manager may be used to order news items from newest news date to oldest news date, for example, and may be used to limit the number of news items on the site or on the page.

The use of the present system and method has been illustrated with a “news” activator, although it has been stated that other types of activators can be employed, and that those skilled in software applications, and in script applications and database design in connection with internet applications will readily appreciate how the present invention can be applied to other types of functionality of broad or industry-specific applicability, another functional application of the present invention will now be described, namely, the contact manager.

Many web sites provide a way for those visiting the site to contact the site owner and request additional product information or apply for jobs. This type of functionality in which the visitor enters information that allows the site owner and visitor to contact each other is sometimes referred to as a contact page. Although the scope of information will vary, it inevitably includes name, address, phone number and a place to indicate the reason for the contact by the visitor.

In the present invention, a contact activator captures the information provided by the site visitor who completes contact page 160 and allows the site owner to sort visitors by group. This sorting procedure may take place automatically, for example, if contact form 160 is provided only for those looking for job-related responses, if there are different contact forms 160 for different purposes on the web site, or if there is a drop down menu provided as part of contact form 160 for use by the web site visitor to indicate the purpose of the contact. Those visitors indicating an interest, for example, in new products, jobs or information about a topic would fall into those three groups.

Once a group of contacts has been generated, or names and contact information added from other sources in addition to those who contact the web site owner through contact form 160, email messages or site content sent to the members of the group.

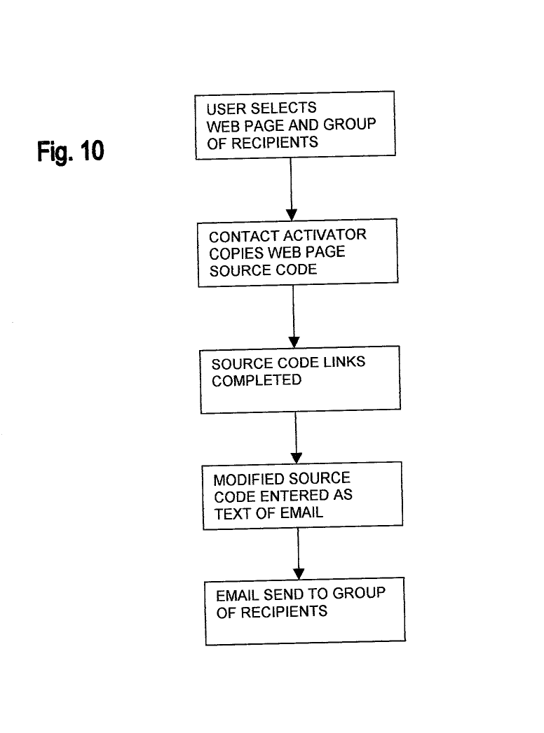

The user can then instruct the administrator to send information to those visitors that relates to their group. For example, if the groups consists of those seeking a clerical job, information about a posting on the web site of a new clerical position, can be sent by email to the members of that group. As another example, if visitors to a web site about new automobiles indicate an interest in a particular make of automobile, they can be sent by email information about that make of automobile when and if it becomes available. A series of dialog boxes as illustrated in FIG. 10A, which shows a screen shot 164 of the e-contact activator work page allows the user to prepare the group email and its contents easily.

These dialog boxes include a box 166 for identifying the party from whom the email came and a box 168 for identifying that party's email address. A box 170 is used to select the particular group that will receive the email. Optionally, a copy of the email can be sent to an archive, using box 172. The user uses box 174 to specify the subject of the email and box 176 for a message to accompany it.

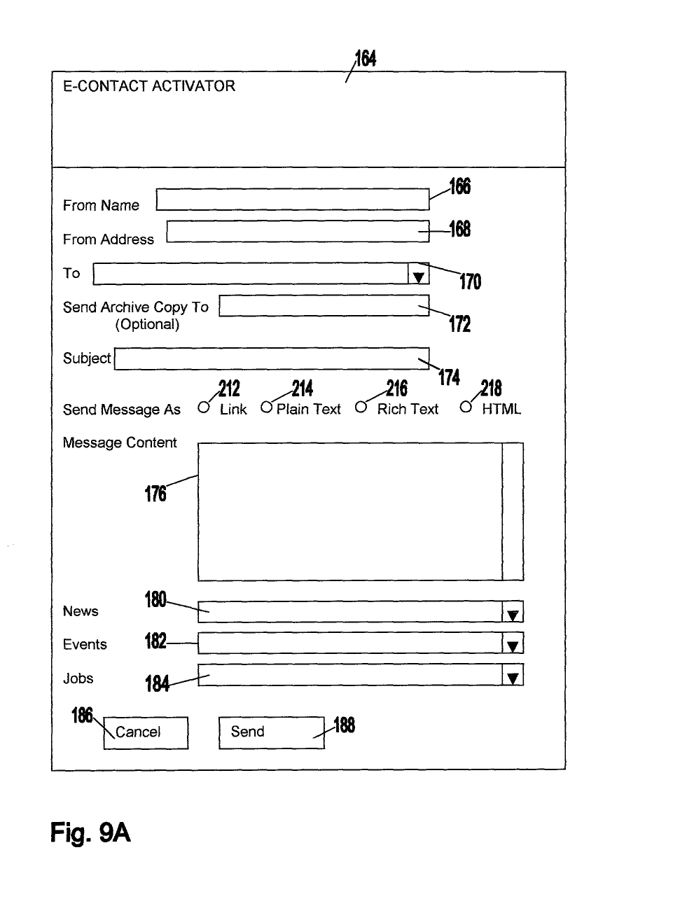

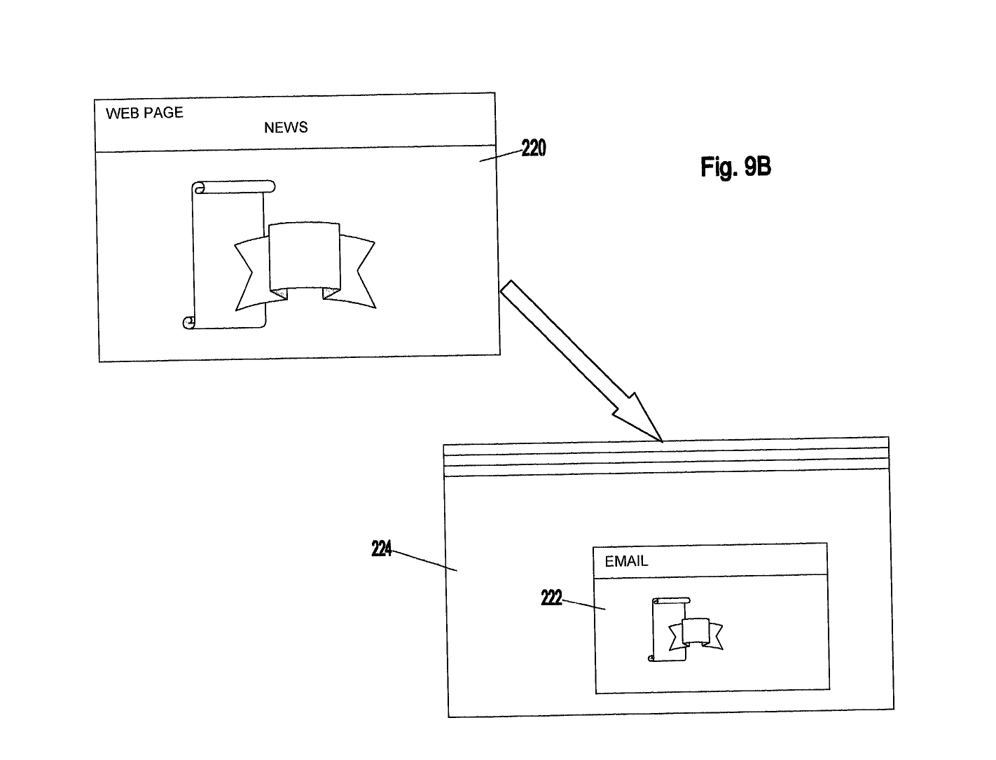

The user specifies the form of the email from the choices presented: a hyperlink to the web site, plain text, rich text format or HTML. A set of drop down menus appear below the message box 176, one for each activator that has been activated (using coding assistant 40, as described above). FIG. 9A shows three activators active: news, events and jobs. If the site content to be sent in HTML format is a news item, the drop down menu in box 180 is used to select the particular news item. If the content to be sent is an event, box 182 is used to select the event. Similarly, if information about a particular job is to be sent, box 184 is used to identify the particular job.

Once the user has selected the portion of the web site to send and identified the group, the user can hit the “send” button 186 of this application (or chose the cancel button 188 to cancel the task). The web page information can be sent as text 212, as a link 214, in rich text format 216 or as HTML 218.

Referring now to FIGS. 9B and 10, after the user has confirmed that the user wants to send the web page that has been selected to the group of recipients that has been designated, the software will copy the source code for that web page and then modify it as needed so that the full path to each link and image that make up the page are complete. The copy of the thus-modified source code of web page 220 then becomes the email text message 222 sent to each of the recipients.

When the recipient opens the email message, assuming that the recipient has an active browser, the browser will display the web page within the window of the email (FIG. 9B). All of the links in the emailed web page will be operative so that the web page will be fully navigable.

If the recipient's browser is not active, the text of the site only will appear. As an option to sending HTML, the information is also sendable by text (plain or rich text) can be sent as a hyperlink. If sent as HTML to a member of a group that was inquiring as to when a new model car was going to be available, the response selected could be a fully navigable image of the web site at the page where an image of the new model and corresponding text is shown.

It will be apparent to those skilled in the art that many changes and substitutions can be made to the preferred embodiment herein described without departing from the spirit and scope of the present invention.

What is claimed is:

1. A method for making a web site, said method comprising the steps of:
creating a static web page;
creating a database coupled to a computer network and adapted to store content data and presentation logic separately;
populating said database with content data and presentation logic;
establishing an activator capable of querying said database for said content data and said presentation logic when said web page is called, said activator being adapted for combining said content data and presentation logic; and
generating source code from said combined content data and presentation logic, said source code being adapted for use by a browser in displaying said content in accordance with said presentation logic as part of said web page.

2. The method as recited in claim 11, further comprising the step of providing a user interface to said database so that said database can be populated with values of said presentation logic.

3. The method as recited in claim 1, further comprising the step of providing a user interface to said database so that said database can be populated with values of said content data.

4. The method as recited in claim 1, further comprising the step of placing a script within a web page that queries said database for presentation logic when said web page is requested.

5. The method as recited in claim 1, wherein said activator is adapted to execute a script within said requested web page, said adaptor querying said database in executing said script.

6. The method as recited in claim 5, wherein said establishing step is achieved using a browser-based software application.

7. The method as recited in claim 2, wherein said populating step is achieved using a browser-based software application.

8. The method as recited in claim 1, wherein said generating step generates code in HTML format.

9. A system for creating and altering a web site, said system comprising:
a database adapted to store content data and presentation logic for a web site, said database coupled to a computer network;
means for populating said database with content data and presentation logic;
query means in operational connection with said database for querying said content data and said presentation logic corresponding to a web page in said web site in response to a request for said web page; and
source code generation means in operational connection with said query means for generating source code in response to receipt of content data and presentation logic retrieved by said query means from said database, said code being capable of interpretation by a web browser.

10. The system as recited in claim 9, wherein said populating means further comprises:
coding means for generating and entering presentation logic; and
content means for entering content data.

11. The system as recited in claim 9, further comprising:
an email system adapted for creating an email message having a text box; and
means for entering said source code into said text box of said email system.

12. The system as recited in claim 9, wherein said database is adapted to house content data and presentation logic for a plurality of web sites including a requested web site and said query means queries said database for said content data and said presentation logic corresponding to said requested web site.

13. A method for using a web site, said method comprising:
addressing an email message, said email message having a text box;
accessing source code for a web page;
obtaining a copy of said source code;
copying said source code into said email message text box; and
sending said email.

14. The method as recited in claim 15, further comprising the step of verifying the completeness of all links in said source code.
